(19) United States
(12) Patent Application Publication
(10) Pub. No.: US 2026/0309947 A1
(43) Pub. Date: Oct. 8, 2026

(54) OPTICAL INTERFACE NETWORK CARD AND OPTICAL TRANSMISSION APPARATUS

(71) Applicant: AIP Inc., New Taipei City (TW)

(72) Inventor: Chia LEE, New Taipei City (TW)

(21) Appl. No.: 19/547,804

(22) Filed: Feb. 24, 2026

Related U.S. Application Data
(60) Provisional application No. 63/785,081, filed on Apr. 8, 2025.

(51) Int. Cl. G02B 6/42; G02B 6/38

(52) U.S. Cl. CPC G02B 6/4292; G02B 6/3825; G02B 6/3897

(57) ABSTRACT

An optical interface network card, adapted for use with an optical cable unit, includes a load board, a network chip disposed on the load board, an optical adapter installed on the load board for connection with the optical cable unit, a photonic integrated circuit disposed on the load board and comprising a signal transmitting portion, and an optical coupling assembly installed on the load board and connected between the optical adapter and the signal transmitting portion of the photonic integrated circuit.

### CROSS REFERENCE TO RELATED APPLICATIONS

This application claims the benefit of U.S. provisional patent application Ser. No. 63/785,081, filed Apr. 08, 2025, the entirety of which is incorporated by reference herein.

### BACKGROUND OF INVENTION

### 1. FIELD OF INVENTION

The present invention relates to a technical field of optical adapters, and particularly to an optical interface network card and an optical transmission apparatus.

### 2. Related Art

Generally, data processing devices, such as switches, servers, etc., are equipped with optical fiber network cards for network connecting. Typically, backplanes of fiber optic network cards are provided with one or more ports, which are suitable for cables, such as direct attach cables (DAC) or active optical cables (AOC) with small form-factor pluggable (SFP) interface, and serve as the medium for optical signal transmission. Connectors of the above-mentioned cables are equipped with optical transceivers, which have a larger volume relative to conventional ethernet network cards. In other words, conventional fiber optic network cards must be designed with slots of larger size for insertion of the connectors of the above-mentioned cables. However, the internal space of data processing devices is limited, and the large size of conventional optical fiber network cards hinders the arrangement of other components and fails to optimize the operational efficiency of optical fiber network cards.

### SUMMARY OF INVENTION

An object of the present application is to provide an optical interface network card being compact in size.

Another object of the present application is to provide an optical interface network card compatible with external light sources.

Another object of the present application is to provide an optical transmission apparatus enabling direct optical connection between an optical interface network and an optical cable unit, without the use of interconnection with optical transceiver.

To achieve the above-mentioned objects, the present application provides an optical interface network card, adapted for use with an optical cable unit, and comprising a load board; a network chip disposed on the load board; an optical adapter installed on the load board for connection with the optical cable unit; a photonic integrated circuit disposed on the load board and comprising a signal transmitting portion; and an optical coupling assembly installed on the load board and connected between the optical adapter and the signal transmitting portion of the photonic integrated circuit.

Optionally, the optical coupling assembly comprises a fiber array unit comprising a connecting head, a ferrule element, and a plurality of optical fibers connected between the connecting head and the ferrule element, wherein the connecting head is connected to the optical adapter, and the ferrule element is positioned to correspond to the signal transmitting portion of the photonic integrated circuit, such that the plurality of optical fibers are optically connected with the signal transmitting portion.

Optionally, the optical coupling assembly further comprises an optical connector, a connecting base disposed on the photonic integrated circuit, and a waveguide substrate, wherein the optical connector comprises the ferrule element and is detachably connected to the connecting base, and the waveguide substrate is positioned in the connecting base and in optical alignment between the plurality of optical fibers and the signal transmitting portion of the photonic integrated circuit.

Optionally, the waveguide substrate integrally extends from the photonic integrated circuit.

Optionally, the optical interface network card further comprises a light source comprising a light emitting module and a light transmitting module, wherein the light emitting module is positioned on the load board and spaced apart from the photonic integrated circuit, and the light transmitting module is connected between the light emitting module and the ferrule element for transmitting light from the light emitting module to the photonic integrated circuit.

Optionally, the optical coupling assembly comprises a connecting base connected between the optical adapter and the photonic integrated circuit, and a waveguide substrate positioned in the connecting base in optical alignment between the optical cable unit and the signal transmitting portion of the photonic integrated circuit.

Optionally, the optical interface network card further comprises a light source comprising a light emitting module and a light transmitting module. The light emitting module is positioned on the load board and spaced apart from the photonic integrated circuit, and the light transmitting module is connected between the light emitting module and the optical cable unit for transmitting light from the light emitting module to the photonic integrated circuit.

Optionally, the optical interface network card further comprises a sub-optical adapter installed on the load board for connection with the light transmitting module, wherein the optical cable unit comprises an optical cable, a plug device positioned at an end of the optical cable and detachably plugged to the optical adapter, and an extension line assembly. The extension line assembly comprises one end located away from the sub-optical adapter and bent toward and extending along the optical cable to connect to the plug device, and another end detachably plugged to the sub-optical adapter.

Optionally, the waveguide substrate integrally extends from the photonic integrated circuit.

Optionally, the load board defines a positioning groove located close to an edge of the load board and passing through opposite surfaces of the load board, such that the optical adapter is located within the positioning groove.

The present application further provides an optical transmission apparatus, comprising an optical interface network card and an optical cable unit. The optical interface network card a load board, a network chip disposed on the load board, an optical adapter installed on the load board, a photonic integrated circuit disposed on the load board and comprising a signal transmitting portion, and an optical coupling assembly installed on the load board and connected between the optical adapter and the signal transmitting portion. The optical cable unit is detachably plugged into the optical adapter and optically connected with the photonic integrated circuit through the optical coupling assembly.

Optionally, the optical coupling assembly comprises a fiber array unit comprising a connecting head, a ferrule element, and a plurality of optical fibers connected between the connecting head and the ferrule element, wherein the connecting head is connected to the optical adapter, and the ferrule element is positioned to correspond to the signal transmitting portion of the photonic integrated circuit, such that the plurality of optical fibers are optically connected with the signal transmitting portion.

Optionally, the optical coupling assembly further comprises an optical connector, a connecting base disposed on the photonic integrated circuit, and a waveguide substrate, wherein the optical connector comprises the ferrule element and is detachably connected to the connecting base, and the waveguide substrate is positioned in the connecting base and in optical alignment between the plurality of optical fibers and the signal transmitting portion of the photonic integrated circuit.

Optionally, the optical transmission apparatus further comprises a light source comprising a light emitting module and a light transmitting module, wherein the light emitting module is positioned on the load board and spaced apart from the photonic integrated circuit, and the light transmitting module is connected between the light emitting module and the ferrule element for transmitting light from the light emitting module to the photonic integrated circuit.

Optionally, the waveguide substrate integrally extends from the photonic integrated circuit.

Optionally, the optical coupling assembly comprises a connecting base connected between the optical adapter and the photonic integrated circuit, and a waveguide substrate positioned in the connecting base in optical alignment between the optical cable unit and the signal transmitting portion of the photonic integrated circuit.

Optionally, the optical cable unit comprises an optical cable and a plug device positioned at an end of the optical cable and detachably plugged to the optical adapter.

Optionally, the optical transmission apparatus further comprises a sub-optical adapter installed on the load board, and a light source comprising a light emitting module and a light transmitting module, wherein the optical cable unit further comprises an extension line assembly comprising one end located away from the sub-optical adapter and bent toward and extending along the optical cable to connect to the plug device, and another end detachably plugged to the sub-optical adapter, wherein the light emitting module is positioned on the load board and spaced apart from the photonic integrated circuit, and the light transmitting module is connected between the light emitting module and the sub-optical adapter for transmitting light from the light emitting module to the photonic integrated circuit sequentially through the extension line assembly and the optical cable.

Optionally, the load board defines a positioning groove located close to the optical adapter and passing through opposite surfaces of the load board, such that the optical adapter is located within the positioning groove.

In the present application, the optical interface network card and the optical transmission apparatus are equipped with the photonic integrated circuit as the medium for light signal transmission, which eliminates the need for space to accommodate a conventional optical transceiver (not shown) connected to the optical cable, thus making the optical interface network card more compact and efficient. In addition, the independently supplied light source for the photonic integrated circuit can provide higher power, optimizing both the size and the efficiency of the entire optical interface network card and the optical transmission apparatus, thereby improving the utilization of the limited internal space in data processing devices.

### BRIEF DESCRIPTION OF DRAWINGS

To describe the technical solutions in the embodiments of the present application more clearly, the accompanying drawings used in the embodiments are briefly described below. It should be noted that the drawings illustrate only some embodiments of the present application, and those skilled in the art may derive other drawings therefrom without departing from the scope of the present application.

FIG. 1 is a schematic perspective view of an optical interface network card in accordance with an embodiment of the present application.

FIG. 2 is a schematic perspective view of an optical interface network card in accordance with an embodiment of the present application.

FIG. 3 is a schematic perspective view of an optical interface network card in accordance with an embodiment of the present application.

FIG. 4 is a schematic perspective view of an optical interface network card in accordance with an embodiment of the present application.

FIG. 5 is a schematic perspective view of an optical interface network card in accordance with an embodiment of the present application.

FIG. 6 is a schematic perspective view of an optical interface network card in accordance with an embodiment of the present application.

FIG. 7 is another perspective view of the optical interface network card of FIG. 6.

### DESCRIPTION OF PREFERRED EMBODIMENTS

The following embodiments refer to the accompanying drawings for exemplifying specific implementable embodiments of the present invention. Directional terms described by the present invention, such as upper, lower, front, back, left, right, inner, outer, side, etc., are only directions by referring to the accompanying drawings, and thus the used directional terms are used to describe and understand the present invention, but the present invention is not limited thereto.

It should be understood that, although the terms first, second, etc. may be used herein to describe various elements, these elements should not be limited by these terms. Unless indicated otherwise, these terms are only used to distinguish one element from another element. Thus, for example, a first element, a first component, or a first section could be termed as a second element, a second component or a second section without departing from the teachings of the present application.

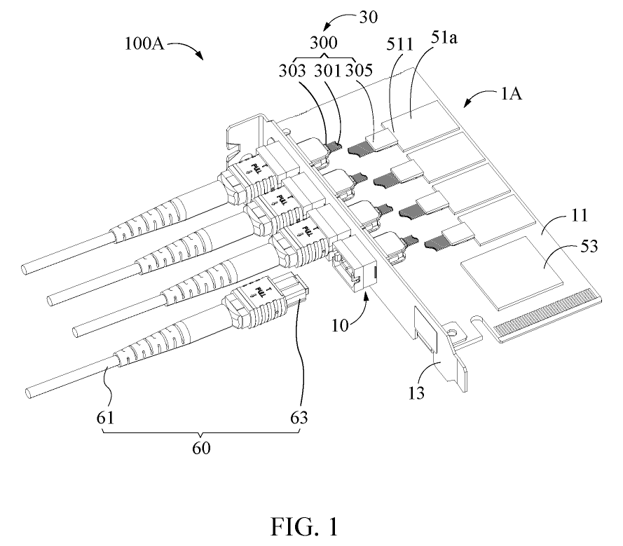

The present application provides an optical interface network card and an optical transmission apparatus that enable optical transmission for servers, switches, or other data processing devices that are equipped with serial bus interfaces, such as peripheral component interconnect express (PCIe) bus, for use with the optical interface network card. Referring to FIG. 1, showing a schematic perspective view of an optical interface network card 1A in accordance with an embodiment of the present application, the optical interface network card 1A includes a load board 11, a plurality of optical adapters 10 spaced apart from each other and installed on the load board 11, a plurality of optical coupling assemblies 30 installed on the load board 11 and correspond to the optical adapters 10 in number, a plurality of photonic integrated circuits 51a disposed on the load board 11, and a network chip 53 spaced apart from the photonic integrated circuits 51a on the load board 11. In some embodiments, a strip plate-shaped holder 13 is mounted on the load board 11 and forms a plurality of connecting ports for positioning the optical adapters 10. In other embodiments, the optical adapters 10 may be disposed directly on the load board 11. Each of the optical coupling assemblies 30 is composed of a plurality of components that are connected between the optical adapter 10 and a signal transmitting portion 511 of the photonic integrated circuit 51a. Specifically, the signal transmitting portion 511 is configured to enable light signal transmission between the optical coupling assembly 30 and the photonic integrated circuit 51a.

As shown in FIG. 1, each of the optical coupling assemblies 30 includes a connecting head 303, a ferrule element 305, and a plurality of optical fibers 301 that jointly form a fiber array unit 300. It is noted that part of the optical fiber 301 is not shown for clarity. Specifically, the connecting head 303 is disposed on an end of each of the optical fibers 301 and pluggable to the optical adapter 10, and the ferrule element 305 is disposed on the other ends of the optical fibers 301 and is positioned to correspond to the transmitting portion 511. In this embodiment, the ferrule element 305 is permanently and directly connected to the transmitting portion 511 of the photonic integrated circuit 51a.

Still referring to FIG. 1, a plurality of optical cable units 60 are used to be detachably plugged into the optical adapters 10, respectively. The optical cable unit 60 and the optical interface network card 1A together constitute an optical transmission apparatus 100A. Specifically, each of the optical cable units 60 includes an optical cable 61 and a plug device 63. In this embodiment, the plug device 63 has a multi-fiber push on (MPO) structure. In this way, light signals can be transmitted between the optical cable unit 60 and the photonic integrated circuit 51a through the optical coupling assembly 30.

In this embodiment, the photonic integrated circuit 51a and the network chip 53 may be wire-bonded to the load board 11. The photonic integrated circuit 51a is configured for optical-to-electrical signal conversion and electrical-to-optical signal conversion. In some embodiments, the photonic integrated circuit 51a is preferably a silicon photonic integrated circuit and may be made of a silicon-based material. Specifically, the photonic integrated circuit 51a may include at least a light detection module, a light source module, and a plurality of active components and passive components, such as, but not limited to filters or multiplexing structures, optical power distribution structures, optical fiber output and input structure, and light modulation structure. Since the features of the present application do not pertain to the detailed structure of the active and passive optical components, which are known to those skilled in the art, these components will not be described in detail here. In the embodiment shown in FIG. 1, each of the photonic integrated circuits 51a is equipped with a built-in light source that emits light to the fiber array unit 300.

By using the tandem arrangement of the optical coupling assembly 30 and the photonic integrated circuit 51a mounted on the load board 11, the optical interface network card 1A can be reduced in size, as it eliminates the need for space to accommodate a conventional optical transceiver (not shown) connected to the optical cable 61, thereby making the optical interface network card 1A more compact and efficient.

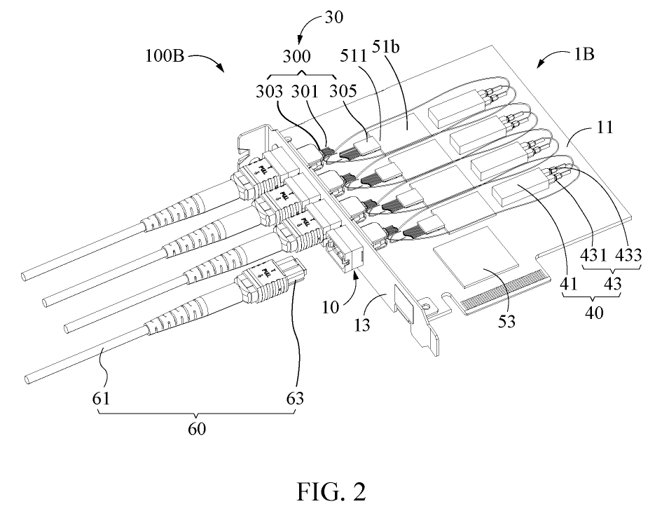

Referring to FIG. 2, showing an optical interface network card 1B in accordance with another embodiment of the present application, the optical interface network card 1B is mainly different from the optical interface network card 1A in that a photonic integrated circuit 51b of the optical interface network card 1B does not include a built-in light source but instead relies on an external light source. It should be noted that the structures of the optical interface network card 1B that are similar to those of the optical interface network card 1A will not be described in detail here. As shown in FIG. 2, a plurality of light sources 40 are provided to serve as external light sources for the photonic integrated circuits 51b, respectively. Specifically, each of the light sources 40 includes a light emitting module 41 and a light transmitting module 43. The light emitting module 41 is positioned on the load board 11 and spaced apart from the photonic integrated circuit 51b, and the light transmitting module 43 is connected between the light emitting module 41 and the ferrule element 305 for transmitting light from the light emitting module 41 to the photonic integrated circuit 51b.

In some embodiments, the light emitting module 41 may include a module housing (not labelled) and a light transmitter (not labelled) housed in the module housing. In detail, the module housing is disposed on the load board 11, and the light transmitter may be detachably pluggable into the module housing. Preferably, the light transmitter is a laser diode. As shown in FIG. 2, the light transmitting module 43 includes a first signal transmission member 431 and a second signal transmission member 433 that are integrated with the optical fibers 301 of the fiber array unit 300. The first signal transmission member 431 and the second signal transmission member 433 each include optical fibers for transmitting optical signals between the light emitting module 41 and the photonic integrated circuit 51b.

Still referring to FIG. 2, a plurality of optical cable units 60 are used to be detachably plugged into the optical adapters 10, respectively. The optical cable units 60 shown in FIG. 2 have substantially the same structure as the optical cable units 60 shown in FIG. 1, which will not be described in detail here. As shown in FIG. 2, the optical cable unit 60 and the optical interface network card 1B together constitute an optical transmission apparatus 100B.

By using the light sources 40 as external light source for the photonic integrated circuit 51b, the size of the photonic integrated circuit 51b can be reduced, and the independently provided light source 40 can be designed with higher power, thereby optimizing both the size and the efficiency of the entire optical interface network card 1B.

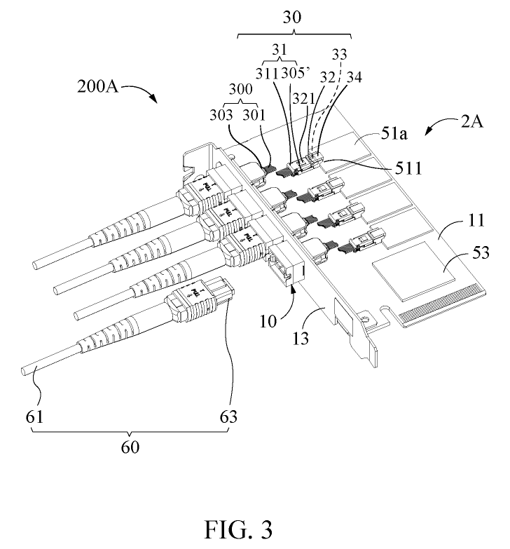

Referring to FIG. 3, which is a schematic perspective view of an optical interface network card 2A in accordance with another embodiment of the present application, the main difference between the optical interface network card 2A and the optical interface network card 1A lies in the structure of the optical coupling assembly 30. As shown in FIG. 3, each of the optical coupling assemblies 30 includes a plurality of optical fibers 301, a connecting head 303, an optical connector 31, a connecting base 32, and a waveguide substrate 33. Specifically, the optical connector 31 includes a ferrule element 305’ and a fastening member 311 movably assembled with the ferrule element 305’, and the connecting base 32 includes an engaging member 321. The ferrule element 305’ is positioned at ends of the optical fibers 301 away from the connecting head 303 and detachably connected to the connecting base 32. The fastening member 311 is configured to detachably engage with the engaging member 321 to further secure the connection between the ferrule element 305’ and the connecting base 32. The waveguide substrate 33 is positioned in the connecting base 32, in optical alignment between the optical fibers 301 and the signal transmitting portion 511 of the photonic integrated circuit 51a.

In some embodiments, the waveguide substrate 33 may be made of silica or silicon depending on specific requirements. The waveguide substrate 33 may include a planar lightwave circuit (PLC), which can be configured in various ways, including, but not limited to, a straight line circuit, a splitter circuit, an arrayed waveguide grating wavelength multiplexer, and a cross connect-type circuit. Different types of waveguide circuits or devices can be utilized for the planar lightwave circuit in waveguide substrate 33 of the present application. In the optical interface network card 2A, each of the photonic integrated circuits 51a is equipped with a built-in light source that emits light to the optical connector 31.

Still referring to FIG. 3, a bridging element 34 is installed on the connecting base 32. Specifically, part of the bridging element 34 is positioned on the waveguide substrate 33, and another part of the bridging element 34 is positioned on the photonic integrated circuit 51a. The use of the bridging element 34 can enhance the structural strength of the photonic integrated circuit 51a and provide the structural force to combine the photonic integrated circuit 51a and the waveguide substrate 33. In some embodiments, the waveguide substrate 33 may integrally extend from the photonic integrated circuit 51a, which can eliminate the need for an additional waveguide converter substrate for optical coupling and simplify the structure.

In the embodiment shown in FIG. 3, the photonic integrated circuit 51a and the network chip 53 may be flip-chip mounted onto the load board 11. It should be noted that based on the detachable connection between the optical connector 31 and the photonic integrated circuit 51a, the assembly of the photonic integrated circuit 51a and the waveguide substrate 33 in combination with the load board 11 can proceed to a reflow process or a back-end process under high temperatures, with both the optical fibers 301 and the optical connector 31 detached from the photonic integrated circuit 51a. Therefore, the optical fibers 301 would not be damaged by the high temperatures during the above-mentioned processes.

Still referring to FIG. 3, a plurality of optical cable units 60 are used to be detachably plugged into the optical adapters 10, respectively. The optical cable units 60 shown in FIG. 3 have substantially the same structure as the optical cable units 60 shown in FIG. 1, which will not be described in detail here. As shown in FIG. 3, the optical cable unit 60 and the optical interface network card 2A together constitute an optical transmission apparatus 200A.

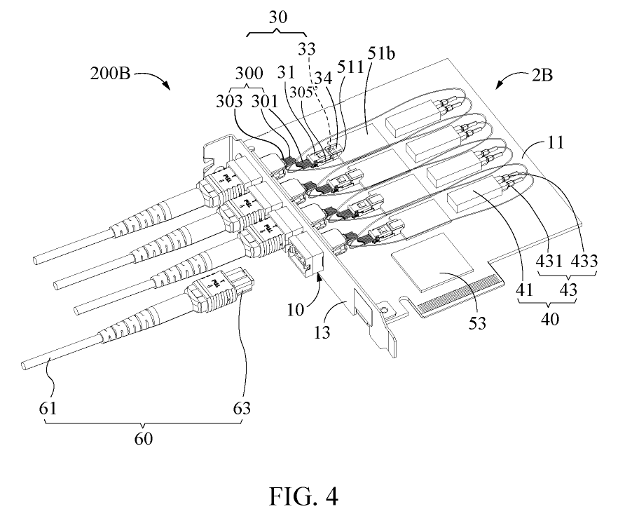

Referring to FIG. 4, which is a schematic perspective view of an optical interface network card 2B in accordance with another embodiment of the present application, the main difference between the optical interface network card 2B and the optical interface network card 2A lies in that a photonic integrated circuit 51b of the optical interface network card 2B does not include a built-in light source but instead relies on an external light source. As shown in FIG. 4, a plurality of light sources 40 are provided to serve as external light sources for the photonic integrated circuits 51b, respectively. It should be noted that the light source 40 shown in FIG. 4 has substantially the same structure as the light source 40 shown in FIG. 2.

As shown in FIG. 4, each of the light sources 40 includes a light emitting module 41 and a light transmitting module 43. The light emitting module 41 is positioned on the load board 11 and spaced apart from the photonic integrated circuit 51b, and the light transmitting module 43 is connected between the light emitting module 41 and the optical connector 31 for transmitting light from the light emitting module 41 to the photonic integrated circuit 51b. Specifically, the light transmitting module 43 includes a first signal transmission member 431 and a second signal transmission member 433 that are integrated with the optical fibers 301. The first signal transmission member 431 and the second signal transmission member 433 each include optical fibers for transmitting optical signals between the light emitting module 41 and the photonic integrated circuit 51b.

Still referring to FIG. 4, a plurality of optical cable units 60 are used to be detachably plugged into the optical adapters 10, respectively. The optical cable units 60 shown in FIG. 4 have substantially the same structure as the optical cable units 60 shown in FIG. 1, which will not be described in detail here. As shown in FIG. 4, the optical cable unit 60 and the optical interface network card 2B together constitute an optical transmission apparatus 200B.

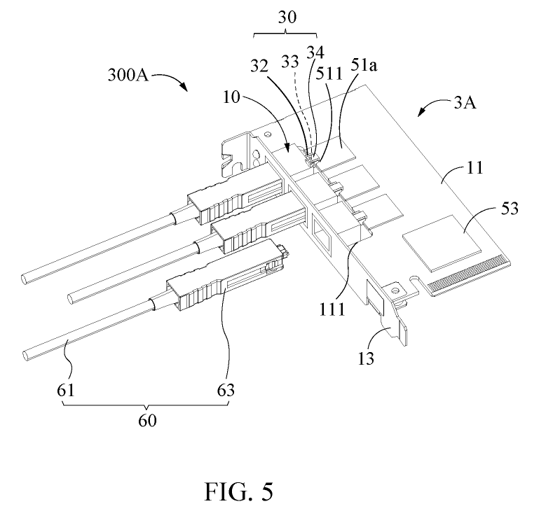

Referring to FIG. 5, which is a schematic perspective view of an optical interface network card 3A in accordance with another embodiment of the present application, in this embodiment, the optical coupling assembly 30 of the optical interface network card 3A eliminates the use of the fiber array unit 300 and the optical connector 31, while remaining the connecting base 32. Similarly, the waveguide substrate 33 is positioned in the connecting base 32 in optical alignment with the signal transmitting portion 511 of the photonic integrated circuit 51a. In this embodiment, the photonic integrated circuits 51a of the optical interface network card 3A are equipped with built-in light sources, respectively. Since the fiber array unit 300 and the optical connector 31 are omitted, the size of the optical interface network card 3A can be significantly reduced, making it more compact. It should be noted that the structure of the optical interface network card 3A, shown in FIG. 5, which is substantially the same as that of the optical interface network cards 1A and 2A, will not be described in detail here.

In some embodiments, the load board 11 of the optical interface network card 3A defines a positioning groove 111 located close to the optical adapters 10 and passing through opposite surfaces of the load board 11. In doing so, the optical adapters 10 are located within the positioning groove 111, allowing the plug devices 63 to be inserted into the optical adapters 10 at a location where light signals can be directly transmitted from the waveguide substrate 33 to the plug devices 63.

As shown in FIG. 5, the plug device 63 of the optical cable unit 60 is a high-speed connector, which can improve signal transmission performance. In this embodiment, the plurality of plug devices 63 (the high-speed connectors) of the optical cable units 60 are plugged to the optical adapters 10 to directly connect to the waveguide substrates 33, respectively. Therefore, the signal transmission distance between the waveguide substrate 33 and the optical cable unit 60 can be shortened because of the removal of the fiber array unit 300 and the optical connector 31. In this embodiment, the optical interface network card 3A and the optical cable unit 60 together constitute an optical transmission apparatus 300A.

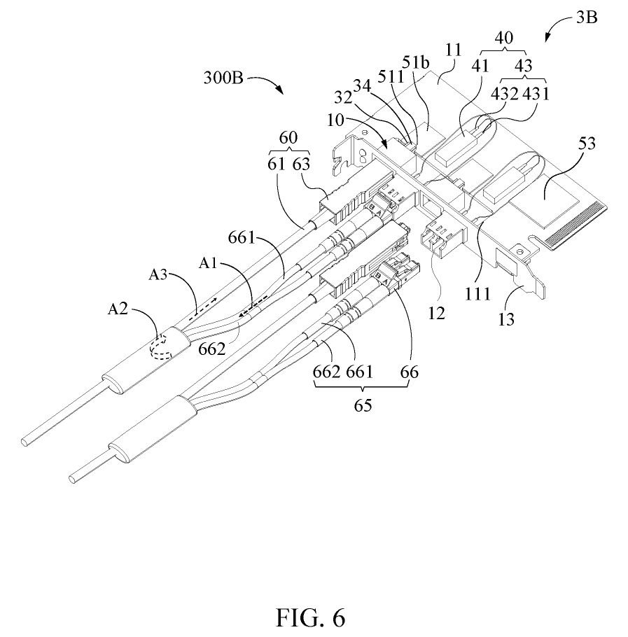

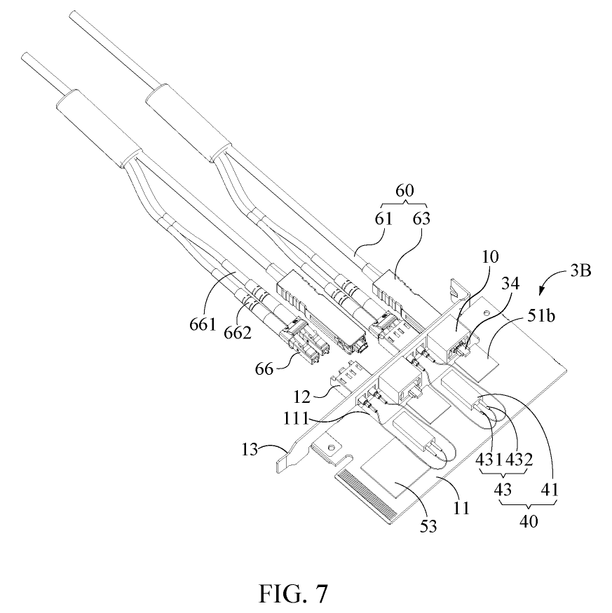

Referring to FIGS. 6 and 7, which are schematic perspective views of an optical interface network card 3B in accordance with another embodiment of the present application, the main difference between the optical interface network card 3B and the optical interface network card 3A lies in that a photonic integrated circuit 51b of the optical interface network card 3B does not include a built-in light source but instead relies on an external light source. As shown in FIG. 6, the optical interface network card 3B includes two light sources 40 each including a light emitting module 41 and a light transmitting module 43. The light emitting module 41 is positioned on the load board 11 and spaced apart from the photonic integrated circuit 51b, and the light transmitting module 43 is connected between the light emitting module 41 and the optical cable unit 60 for transmitting light from the light emitting module to the photonic integrated circuit 51b. In this embodiment, the optical interface network card 3B and the optical cable unit 60 together constitute an optical transmission apparatus 300B.

As shown in FIG. 6, a holder 13 is mounted on the load board 11. A plurality of optical adapters 10 and sub-optical adapters 12 are alternatively arranged on the holder 13, with each optical adapter 10 positioned alongside a sub-optical adapter 12 as a set. Each of the optical cable units 60 includes an optical cable 61, a plug device 63 positioned at an end of the optical cable 61 and detachably plugged to the optical adapter 10, and an extension line assembly 65. Specifically, the extension line assembly 65 includes one end located away from the sub-optical adapter 12 and bent toward and extending along the optical cable 61 to connect to the plug device 63, and another end detachably plugged to the sub-optical adapter 12 for connection with the light transmitting module 43. In detail, the extension line assembly 65 includes an optical plug 66, a first signal line 661, and a second signal line 662. The optical plug 66 is inserted into one end of the sub-optical adapter 12 outside the load board 11, and the first signal transmission member 431 and the second signal transmission member 433 are connected to the other end of the sub-optical adapter 12 opposite to the optical plug 66.

Still referring to FIG. 6, each of the first signal line 661 and the second signal line 662 has one end connected to the optical plug 66 and the other end integrated with the optical cable 61. In some embodiments, the light emitting module 41 emits light, which travels from the light transmitting module 43 into the first signal line 661 outside of the load board 11 in a first direction (indicated by an arrow A1). The light then turns toward the optical cable 61 (indicated by an arrow A2) and travels in a second direction (indicated by an arrow A3), which is opposite to the first direction, along the optical cable 61 to reach the plug devices 63. Finally, the light enters the photonic integrated circuit 51b through the waveguide substrate 33. In doing so, the light junction of the light transmitting module 43 and the optical cable 61 is outside the load board 11, thereby further reducing the size of the optical interface network card 3B.

The present application further provides an optical transmission apparatus, including a load board; a network chip disposed on the load board; an optical adapter installed on the load board; a photonic integrated circuit disposed on the load board and comprising a signal transmitting portion; and an optical coupling assembly installed on the load board and connected between the optical adapter and the signal transmitting portion; and an optical cable unit detachably plugged to the optical adapter and optically connected with the photonic integrated circuit through the optical coupling assembly.

Accordingly, the optical interface network card and the optical transmission apparatus are equipped with the photonic integrated circuit as the medium for light signal transmission, which eliminates the need for space to accommodate a conventional optical transceiver (not shown) connected to the optical cable, thus making the optical interface network card more compact and efficient. In addition, the independently supplied light source for the photonic integrated circuit can provide higher power, optimizing both the size and the efficiency of the entire optical interface network card and the optical transmission apparatus, thereby improving the utilization of the limited internal space in data processing devices.

Although the present invention has been disclosed as a preferred embodiment, it is not intended to limit the present invention. Those skilled in the art without departing from the scope of the present invention may make various changes or modifications, and thus the scope of the present invention should be after the appended claims and their equivalents.

What is claimed is:

1. An optical interface network card, adapted for use with an optical cable unit, and comprising:
a load board;
a network chip disposed on the load board;
an optical adapter installed on the load board for connection with the optical cable unit;
a photonic integrated circuit disposed on the load board and comprising a signal transmitting portion; and
an optical coupling assembly installed on the load board and connected between the optical adapter and the signal transmitting portion of the photonic integrated circuit.

2. The optical interface network card of claim 1, wherein the optical coupling assembly comprises a fiber array unit comprising a connecting head, a ferrule element, and a plurality of optical fibers connected between the connecting head and the ferrule element, wherein the connecting head is connected to the optical adapter, and the ferrule element is positioned to correspond to the signal transmitting portion of the photonic integrated circuit, such that the plurality of optical fibers are optically connected with the signal transmitting portion.

3. The optical interface network card of claim 2, wherein the optical coupling assembly further comprises an optical connector, a connecting base disposed on the photonic integrated circuit, and a waveguide substrate, wherein the optical connector comprises the ferrule element and is detachably connected to the connecting base, and the waveguide substrate is positioned in the connecting base and in optical alignment between the plurality of optical fibers and the signal transmitting portion of the photonic integrated circuit.

4. The optical interface network card of claim 3, wherein the waveguide substrate integrally extends from the photonic integrated circuit.

5. The optical interface network card of claim 2, further comprising a light source comprising a light emitting module and a light transmitting module, wherein the light emitting module is positioned on the load board and spaced apart from the photonic integrated circuit, and the light transmitting module is connected between the light emitting module and the ferrule element for transmitting light from the light emitting module to the photonic integrated circuit.

6. The optical interface network card of claim 1, wherein the optical coupling assembly comprises a connecting base connected between the optical adapter and the photonic integrated circuit, and a waveguide substrate positioned in the connecting base in optical alignment between the optical cable unit and the signal transmitting portion of the photonic integrated circuit.

7. The optical interface network card of claim 6, further comprising a light source comprising a light emitting module and a light transmitting module, wherein the light emitting module is positioned on the load board and spaced apart from the photonic integrated circuit, and the light transmitting module is connected between the light emitting module and the optical cable unit for transmitting light from the light emitting module to the photonic integrated circuit.

8. The optical interface network card of claim 7, further comprising a sub-optical adapter installed on the load board for connection with the light transmitting module, wherein the optical cable unit comprises an optical cable, a plug device positioned at an end of the optical cable and detachably plugged to the optical adapter, and an extension line assembly, wherein the extension line assembly comprises one end located away from the sub-optical adapter and bent toward and extending along the optical cable to connect to the plug device, and another end detachably plugged to the sub-optical adapter.

9. The optical interface network card of claim 6, wherein the waveguide substrate integrally extends from the photonic integrated circuit.

10. The optical interface network card of claim 6, wherein the load board defines a positioning groove located close to optical adapter and passing through opposite surfaces of the load board, such that the optical adapter is located within the positioning groove.

11. An optical transmission apparatus, comprising:
an optical interface network card, comprising:
a load board;
a network chip disposed on the load board;
an optical adapter installed on the load board;
a photonic integrated circuit disposed on the load board and comprising a signal transmitting portion; and
an optical coupling assembly installed on the load board and connected between the optical adapter and the signal transmitting portion; and
an optical cable unit detachably plugged to the optical adapter and optically connected with the photonic integrated circuit through the optical coupling assembly.

12. The optical transmission apparatus of claim 11, wherein the optical coupling assembly comprises a fiber array unit comprising a connecting head, a ferrule element, and a plurality of optical fibers connected between the connecting head and the ferrule element, wherein the connecting head is connected to the optical adapter, and the ferrule element is positioned to correspond to the signal transmitting portion of the photonic integrated circuit, such that the plurality of optical fibers are optically connected with the signal transmitting portion.

13. The optical transmission apparatus of claim 12, wherein the optical coupling assembly further comprises an optical connector, a connecting base disposed on the photonic integrated circuit, and a waveguide substrate, wherein the optical connector comprises the ferrule element and is detachably connected to the connecting base, and the waveguide substrate is positioned in the connecting base and in optical alignment between the plurality of optical fibers and the signal transmitting portion of the photonic integrated circuit.

14. The optical transmission apparatus of claim 12, further comprising a light source comprising a light emitting module and a light transmitting module, wherein the light emitting module is positioned on the load board and spaced apart from the photonic integrated circuit, and the light transmitting module is connected between the light emitting module and the ferrule element for transmitting light from the light emitting module to the photonic integrated circuit.

15. The optical transmission apparatus of claim 13, wherein the waveguide substrate integrally extends from the photonic integrated circuit.

16. The optical transmission apparatus of claim 11, wherein the optical coupling assembly comprises a connecting base connected between the optical adapter and the photonic integrated circuit, and a waveguide substrate positioned in the connecting base in optical alignment between the optical cable unit and the signal transmitting portion of the photonic integrated circuit.

17. The optical transmission apparatus of claim 11, wherein the optical cable unit comprises an optical cable and a plug device positioned at an end of the optical cable and detachably plugged to the optical adapter.

18. The optical transmission apparatus of claim 17, further comprising a sub-optical adapter installed on the load board, and a light source comprising a light emitting module and a light transmitting module, wherein the optical cable unit further comprises an extension line assembly comprising one end located away from the sub-optical adapter and bent toward and extending along the optical cable to connect to the plug device, and another end detachably plugged to the sub-optical adapter, wherein the light emitting module is positioned on the load board and spaced apart from the photonic integrated circuit, and the light transmitting module is connected between the light emitting module and the sub-optical adapter for transmitting light from the light emitting module to the photonic integrated circuit sequentially through the extension line assembly and the optical cable.

19. The optical transmission apparatus of claim 16, wherein the load board defines a positioning groove located close to the optical adapter and passing through opposite surfaces of the load board, such that the optical adapter is located within the positioning groove.
